(19) United States
(12) Patent Application Publication
(10) Pub. No.: US 2004/0086165 A1
(43) Pub. Date: May 6, 2004

(54) Pattern identification system

(75) Inventors: Kun-Lang Yu, Keelung (TW); Ching-Fuh Lin, Hsinchuang City (TW); Andy Cheng, Taipei (TW)

Correspondence Address: BACON & THOMAS, PLLC, 625 SLATERS LANE, FOURTH FLOOR, ALEXANDRIA, VA, 22314

(73) Assignee: Star News Network Co., Ltd., Hsichih City (TW)

(21) Appl. No.: 10/689,055

(22) Filed: Oct. 21, 2003

(30) Foreign Application Priority Data
Nov. 1, 2002 (TW) 91132639

(51) Int. Cl. G06K 9/00; G07D 7/00; G06K 9/64

(52) U.S. Cl. 382/135; 382/217; 902/7

(57) ABSTRACT

A pattern identification system includes an illumination device, a video camera unit, a controller and a programmable identification member. The illumination device projects light on a sample pattern disposed in the system. The video camera unit captures a first image for measuring a reference coordinate of the sample pattern. The video camera unit is moved to a predetermined position by the controller. The controller controls the video camera to magnify an image sufficient for identification so as to allow capturing an identifiable image of difference with respect to a programmed feature. The video camera unit captures a second identifiable image of the sample pattern and sends it to the programmable identification member for identifying the sample pattern.

### BACKGROUND OF THE INVENTION

1. Field of the Invention

The present invention is related to a pattern identification system. More particularly, the present invention is related to the pattern identification system for processing and identifying an image of a pattern to prevent fraud.

2. Description of the Related Art

Currently, computer color printing has been continuously progressed that encourages to widely spread forging and copies. Since the forging and copies of various patterns cannot be identified, counterfeits of identification, valuable paper and currency can easily conduct vision of civilians to confusion and failure in recognition. In addition to failure in recognition, eyes of identifiers cannot speed up recognition with thousands of articles. Hence, there is a need for a pattern identification system or device to recognize the counterfeits of identification, valuable paper and currency.

Taiwanese Patent Publication No. 490054, published on Jun. 1, 2002, discloses an anti-counterfeit machine for currency. The anti-counterfeit machine has a sensor system for measuring and checking security features (such as hidden number) of banknotes. The anti-counterfeit machine employs a three-D scanning camera which captures an image of hidden number of notes and identifies it as a real or fake one.

However, the anti-counterfeit machine of No. 490054 for checking hidden number of banknotes must be limited by various design choices (such as patterns and printing lines of banknote) and types (specifications of nations and sizes) of banknotes. Once a version of the banknotes is corrected, the anti-counterfeit for the former banknotes cannot further be used that results in an increase of manufacturing cost. Furthermore, there are two drawbacks for measuring an image of printing lines of hidden numbers. First, after using over a long time, printing lines of the banknotes may be faded out specific that results in failure in recognition. Second, outer light, UV beam or detection light for raised ink may affect operation of the three-D scanning camera of the anti-counterfeit machine that results in a reduced percentage of accuracy in recognition.

Generally, a public document or a certificate may not provide with particular security features. However, the anti-counterfeit machine of No. 490054 is suitable for checking security features (such as raised ink, relief printing, security thread, iridescent shifting ink, fluorescence pattern and laser pattern) of banknotes and valuable papers, but unsuitable for checking an embossing stamp pressed on a graduation certificate or a birth certificate. As a result, it is inconvenient for recognition only for the embossing stamp of the graduation certificate or the birth certificate.

With regard to iridescent shifting ink or fluorescence filament, it is easy to counterfeit or forge and uneasy to identify it in vision. Using a counterfeit detection device, there is a possibility of failure in recognition of iridescent shifting ink and fluorescence filament which may be faded out and abraded resulting from a long-term use.

In fact, banknotes, valuable papers, public documents and certificates have common features of printing, spectra and fibers that are adequate to identify features for recognition. Although computer color printing and copy have been continuously progressed, common features of printing, spectra and fibers cannot be forged and copied, namely, the common features between true and false are distinguishable. Accordingly, the features of general public documents and certificates are adequate to be identified without providing with security features. Credit cards, banknotes and valuable papers with security features still have common features of printing, spectra and fibers are adequate to be identified.

Simply, there is no need for identifying a security feature of forges and copies but only a need for necessarily identifying features of printing, spectra and fibers.

The present invention intends to provide a pattern identification system which is used to identify features of printing, spectra and fibers of an image captured from a predetermined point of a pattern in such a way to mitigate and overcome the above problem.

### SUMMARY OF THE INVENTION

The primary objective of this invention is to provide a pattern identification system to identify features of printing, spectra and fibers of an image, captured from a predetermined point of a sample pattern, by sufficiently magnifying it to obtain an identifiable image of difference with respect to a programmed feature. Thereby, the pattern identification system can improve the identification process.

The secondary objective of this invention is to provide a pattern identification system to identify features of printing, spectra and fibers of an image, captured from a predetermined point of a sample pattern, without a process for comparing it with a reference image. Thereby, the pattern identification system can simplify the identification process.

The pattern identification system in accordance with the present invention includes an illumination device, a video camera unit (containing a controllable camera lens), a controller and a programmable identification member. The illumination device initially projects light on a sample pattern disposed in the system. The video camera unit captures a first image for measuring a reference coordinate of the sample pattern. According to the reference coordinate of the sample pattern, the video camera unit is moved to a predetermined position by the controller. The controller controls the video camera to magnify an image sufficient for identification at the predetermined position of the sample pattern so as to allow capturing an identifiable image of difference with respect to a programmed feature. The video camera unit captures a second identifiable image of the predetermined position of the sample pattern and sends it to the programmable identification member for identifying the sample pattern.

Another embodiment of the present invention is a pattern identification system comprising a video camera unit consisted of a pair of cameras. The first camera is adapted to measure a reference coordinate of a sample pattern, and the second camera is adapted to capture an image for identification.

Another embodiment of the present invention is a pattern identification system comprising a video camera unit consisted of a pair of cameras which are adapted to capture a front image of a sample pattern, and a rear image of the sample pattern penetrated through a transparent stage or reflected from a mirror.

Another embodiment of the present invention is a pattern identification system comprising an illumination device which projects a particular wavelength and brightness of light on a sample pattern to allow a video camera unit capturing a front image and a rear image of the sample pattern.

Another embodiment of the present invention is a pattern identification system comprising an illumination device consisted of a plurality of illuminants which are disposed above and below a stage so as to project a particular wavelength and brightness of light on a sample pattern.

Another embodiment of the present invention is a pattern identification system comprising an illumination device consisted of a plurality of illuminants which are disposed around a stage.

Another embodiment of the present invention is a pattern identification system comprising an illumination device has a projecting angle with respect to a vertical direction for projecting on a sample pattern.

Another embodiment of the present invention is a pattern identification system further comprising a display device to display an identified result of a sample pattern.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a block diagram of a pattern identification system in accordance with a first embodiment of the present invention;

FIG. 2 is a flow chart of the pattern identification system in accordance with the first embodiment of the present invention;

FIG. 3 is a schematic side view of a pattern identification system in accordance with a second embodiment of the present invention;

FIG. 4 is a flow chart of the pattern identification system in accordance with the second embodiment of the present invention;

FIG. 5 is a schematic side view of an illustration device and a video camera unit of a pattern identification system in accordance with a third embodiment of the present invention;

FIG. 6 is a schematic side view of an illustration device and a video camera unit of a pattern identification system in accordance with a fourth embodiment of the present invention;

FIG. 7 is a schematic side view of an illustration device and a video camera unit of a pattern identification system in accordance with a fifth embodiment of the present invention;

FIG. 8 is a schematic side view of an illustration device and a video camera unit of a pattern identification system in accordance with a sixth embodiment of the present invention;

FIG. 9 is a schematic side view of an illustration device and a video camera unit of a pattern identification system in accordance with a seventh embodiment of the present invention;

FIG. 10 is a schematic top view of an illustration device of a pattern identification system in accordance with an eighth embodiment of the present invention; and

FIG. 11 is a schematic top view of an illustration device of a pattern identification system in accordance with an ninth embodiment of the present invention.

### DETAILED DESCRIPTION OF THE INVENTION

The term “video camera unit,” defined in the present invention, includes a single camera lens or at least two camera lenses, and does not exclude any type and specification of modern camera devices, such as a CCD (Charge-Coupled Device). The term “controller,” defined in the present invention, pertains to a control logical circuit, a control IC or a CPU (Central Processing Unit). And, the term “programmable identification member,” defined in the present invention, pertains to an identification logical circuit or an identification database of a computer software.

In the technical field, as will be readily apparent to one skilled in the art, a pattern identification system in accordance with the present invention is incorporated into a portable electronic device or a banknote counting machine.

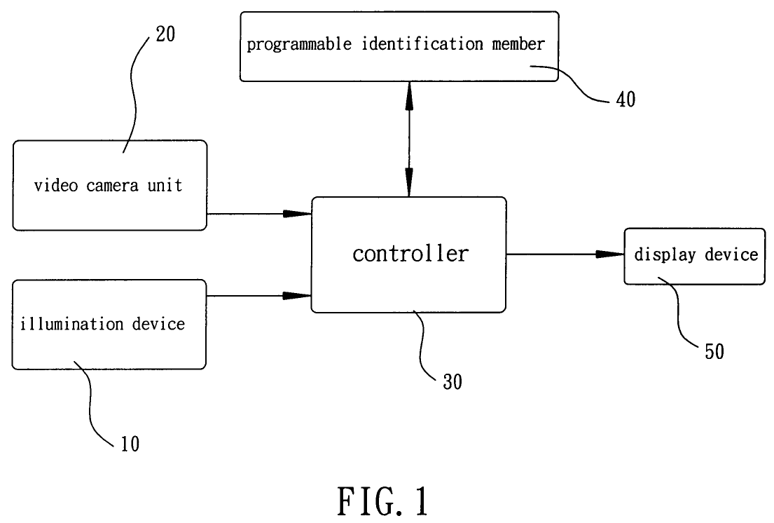

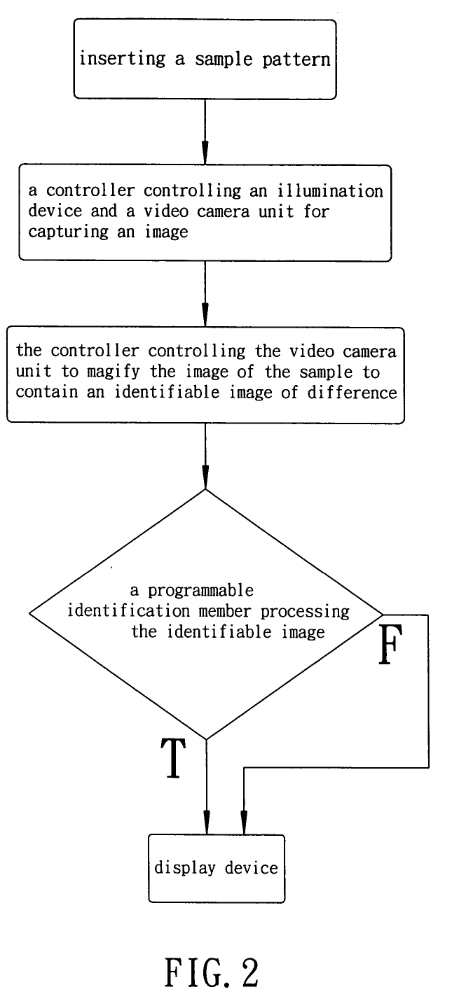

FIG. 1 illustrates a block diagram of a pattern identification system in accordance with a first embodiment of the present invention; and FIG. 2 illustrates a flow chart of the pattern identification system in accordance with the first embodiment of the present invention.

Referring initially to FIG. 1, the pattern identification system in accordance with the first embodiment of the present invention includes an illumination device 10, a video camera unit 20, a controller 30, a programmable identification member 40 and a display device 50. The controller 30 is connected with the illumination device 10 and the video camera unit 20. The video camera unit 20 is adapted to magnify an image of a sample pattern with a predetermined magnifying times sufficient for identification and to capture an image of the sample pattern. The magnifying times processed by the video camera unit 20 are able to capture an identifiable image of difference with respect to a programmed feature. Subsequently, the controller 30 is connected to the programmable identification member 40 and sent the identifiable image thereto. The programmable identification member 40 is used to process identification for the identifiable image of the sample pattern, and outputted to the display device 50.

Turning now to FIGS. 1 and 2, the sample pattern is initially inserted into the pattern identification system in accordance with the first embodiment of the present invention. The controller 30 controls the video camera unit 20 to aim at the sample pattern. The video camera unit 20 includes an optically magnifying device (not shown) which is capable of magnifying an image of the sample pattern with a predetermined magnifying times.

Subsequently, the controller 30 controls to activate the illumination device 10 and the video camera unit 20 so that the illumination device 10 projects a particular wavelength and brightness of light on the sample pattern and selects a predetermined position of the sample pattern for capturing an image. The illumination device 10 includes a LED or a laser illuminator which can generate red, green, blue, infrared, ultraviolet etc. The video camera unit 20 includes a controllable camera lens which is used to magnify an image of the sample pattern with a predetermined magnifying times to provide an identifiable image of difference and then to capture it.

Subsequently, the controller 30 controls the video camera unit 20 to send the identifiable image to the programmable identification member 40 so as to process an identification procedure. The programmable identification member 40 is able to identify features of printing, spectra and fibers. The identifiable image of the sample pattern is consisted of the above-mentioned features of printing, spectra and fibers.

Subsequently, the programmable identification member 40 has a recognizing logic adapted to process the identifiable image so as to generate a difference between the identifiable image and the recognizing logic, and output an identified result. In the identifying operation, the programmable identification member 40 can be selected from a recognizing logic of a computer software for identifying true or false.

Banknotes, valuable papers, public documents and certificates have unique features of printing, spectra and fibers that are adequate to identify features for recognition. The unique printing features include printing line structure, raised ink, pattern structure, printing color, fiber property, fiber component and fiber density etc.

Finally, the controller 30 activates the display device 50 to display the identified result of the sample pattern.

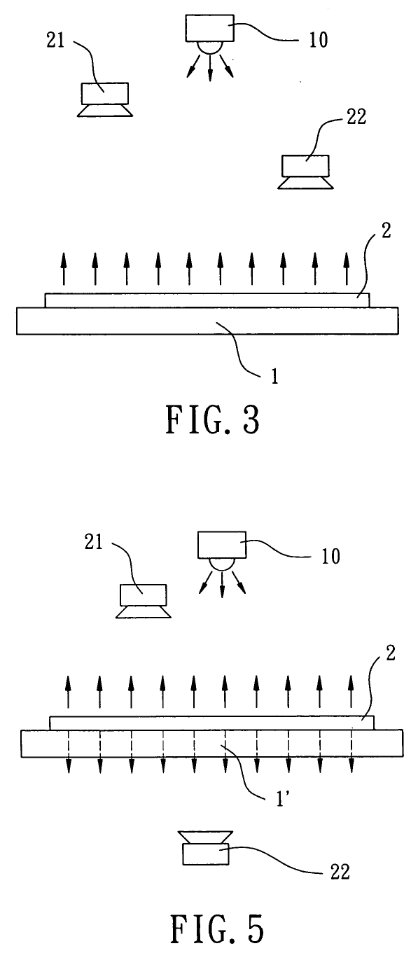

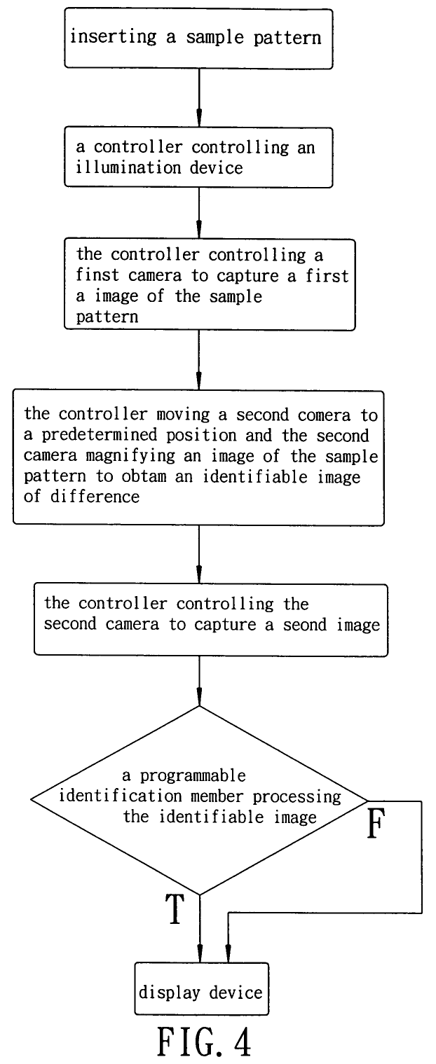

FIG. 3 illustrates a schematic side view of a pattern identification system in accordance with a second embodiment of the present invention; and FIG. 4 illustrates a flow chart of the pattern identification system in accordance with the second embodiment of the present invention. Referring to FIGS. 3 and 4, reference numerals of the second embodiment of the present invention has applied the identical numerals of the first embodiment, as shown in FIGS. 1 and 2. The pattern identification system in accordance with the second embodiment of the present invention has similar configuration and same function as that of the first embodiment and the detailed descriptions may be omitted.

Referring again to FIGS. 3 and 4, as is known in the first embodiment, the illumination device 10 and the video camera unit 20 of the pattern identification system in accordance with the second embodiment are disposed at an upper portion of the pattern identification system. The term “upper,” indicated in the present invention, defines a position above a stage 1 for facing a front surface of a sample pattern 2. Alternatively, the term “lower,” indicated in the present invention, defines a position below the stage 1 for facing a rear surface of the sample pattern 2. The video camera unit 20 is consisted of a first camera 21 and a second camera 22.

Referring again to FIG. 4, when the sample pattern 2 is initially inserted and placed on the stage 1 of the pattern identification system, the first camera 21 and the second camera 22 are commonly corresponding to the front surface of the sample pattern 2.

Subsequently, the controller 30 controls to activate the illumination device 10 to project a particular wavelength and brightness of light on the sample pattern 2.

Subsequently, the controller 30 controls to activate the first camera 21 of the video camera unit 20 to capture a first image of the sample pattern 2 so as to measure a reference coordinate of the sample pattern 2 for selecting a predetermined position.

Subsequently, the controller 30 controls to activate the second camera 22 of the video camera unit 20 to move to a predetermined position according to the measurement of the first camera 21. The second camera 22 magnifies the image of the sample pattern 2 with a predetermined magnifying times to provide an identifiable image of difference and then to capture it.

Subsequently, the controller 30 controls the video camera unit 20 to send the identifiable image to the programmable identification member 40 so as to process an identification procedure for identifying true or false.

Finally, the controller 30 activates the display device 50 to display the identified result of the sample pattern 2.

FIGS. 5 through 9 illustrate schematic side views of illustration devices and video camera units of pattern identification systems in accordance with third through seventh embodiments of the present invention.

Referring to FIGS. 5 through 9, reference numerals of the third through seventh embodiments of the present invention have applied the identical numerals of the first embodiment, as shown in FIGS. 1 and 2. The pattern identification system in accordance with the third through seventh embodiments of the present invention have similar configuration and same function as that of the first embodiment and the detailed descriptions may be omitted.

Turning now to FIG. 5, as is known in the first embodiment, the illumination device 10 of the pattern identification system in accordance with the third embodiment is disposed at the upper portion of the pattern identification system. The first camera 21 of the video camera unit 20 is disposed at an upper portion of the transparent stage 1′ and adapted to capture an image of the front surface of the sample pattern 2. Similarly, the second camera 22 of the video camera unit 20 is disposed at a lower portion of the transparent stage 1′ and adapted to capture an image of the rear surface of the sample pattern 2.

Referring again to FIG. 5, when the sample pattern 2 is initially inserted and placed on the transparent stage 1′ of the pattern identification system, the first camera 21 and the second camera 22 are corresponding to the front surface and the rear surface of the sample pattern 2 respectively.

Subsequently, the controller 30 controls to activate the illumination device 10 to project a particular wavelength and brightness of light on the sample pattern 2.

Subsequently, the controller 30 controls to activate the first camera 21 of the video camera unit 20 to capture a first image of the front surface of the sample pattern 2. Meanwhile the second camera 22 is controlled to capture a second image of the rear surface of the sample pattern 2 through the transparent stage 1′.

Subsequently, the controller 30 controls the first camera 21 and the second camera 22 of the video camera unit 20 to send the identifiable image to the programmable identification member 40 so as to process an identification procedure for identifying true or false.

Finally, the controller 30 activates the display device 50 to display the identified result of the sample pattern 2.

In comparison with the third embodiment, number of the illumination device and the video camera unit in accordance with the fourth through fifth embodiments are added and disposed at the upper portion and lower portion of the stage.

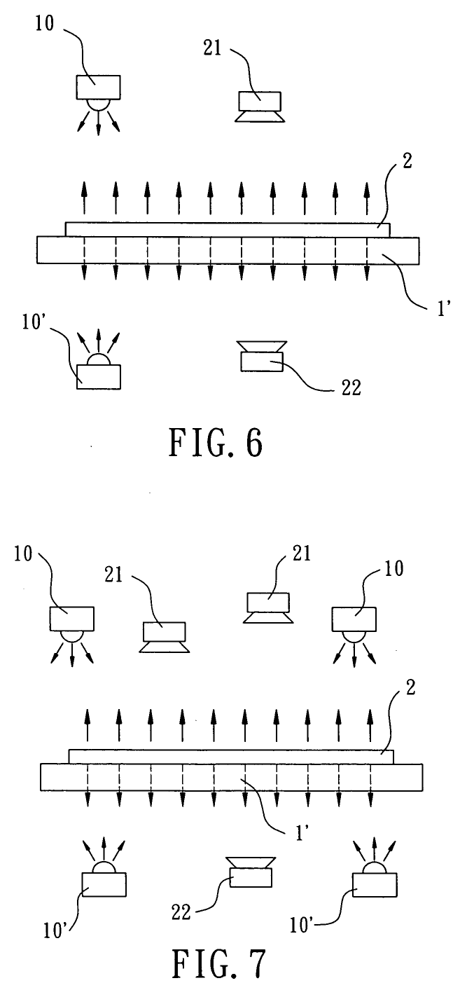

Turning now to FIG. 6, as is known in the first embodiment, the illumination devices 10 and 10′ of the pattern identification system in accordance with the fourth embodiment are disposed at the upper portion and the lower portion of the pattern identification system respectively. The first camera 21 of the video camera unit 20 is disposed at an upper portion of the transparent stage 1′ and adapted to capture images of the front surface of the sample pattern 2. Similarly, the second camera 22 of the video camera unit 20 is disposed at a lower portion of the transparent stage 1′ and adapted to capture an image of the rear surface of the sample pattern 2.

Turning now to FIG. 7, as is known in the first embodiment, the illumination devices 10 and 10′ of the pattern identification system in accordance with the fifth embodiment are disposed at the upper portion and the lower portion of the pattern identification system respectively. Also, the illumination devices 10 and 10′ are disposed along the periphery of the pattern identification system. Two first camera 21 of the video camera unit 20 are disposed at an upper portion of the transparent stage 1′ and adapted to capture images of the front surface of the sample pattern 2. Similarly, the second camera 22 of the video camera unit 20 is disposed at a lower portion of the transparent stage 1′ and adapted to capture an image of the rear surface of the sample pattern 2. In comparison with the fourth embodiment, the illumination device 10 and 10′ of the fifth embodiment are arranged above or below the periphery of the transparent stage 1′.

In comparison with the third embodiment, the illumination device in accordance with the sixth embodiment is adjustable in angle so that the illumination device is able to project the sample pattern at a desired angle and thus the sample pattern appears an angular feature.

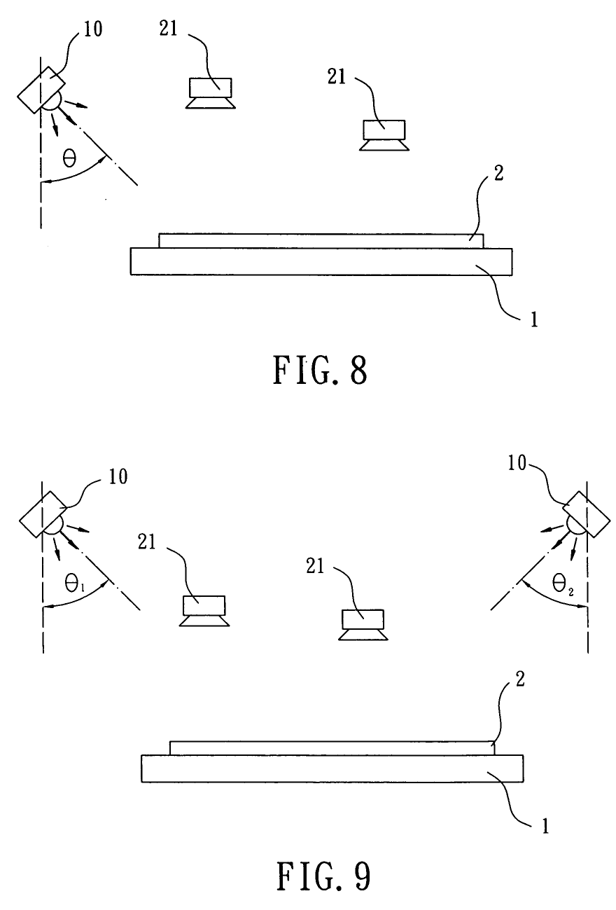

Turning now to FIG. 8, as is known in the first embodiment, the illumination device 10 of the pattern identification system in accordance with the sixth embodiment is disposed at the upper portion of the pattern identification system. The illumination device 10 has a mechanism adapted to mechanically adjust its projecting direction so that it has an included angle (θ) with respect to a vertical direction as well as an incident angle. Two first cameras 21 of the video camera unit 20 are disposed at an upper portion of the transparent stage 1′ and adapted to capture a reflected image of the front surface of the sample pattern 2 which is projected by a particular wavelength with an included angle (θ). Particularly, the first camera 21 of the video camera unit 20 is adapted to capture an angular feature of a reflected image of the sample pattern 2, such as a shifting-ink pattern or a laser pattern.

In comparison with the sixth embodiment, the illumination device in accordance with the seventh embodiment is added so that the illumination device is able to project the sample pattern at multiple desired angles and thus the sample pattern appears multiple angular features.

Turning now to FIG. 9, as is known in the first embodiment, the illumination devices 10 of the pattern identification system in accordance with the seventh embodiment are disposed at opposite edges of the upper portion of the pattern identification system. The illumination devices 10 include at least two angle-adjustable illuminators so that they have two included angles (θ1) and (θ2) with respect to a vertical direction.

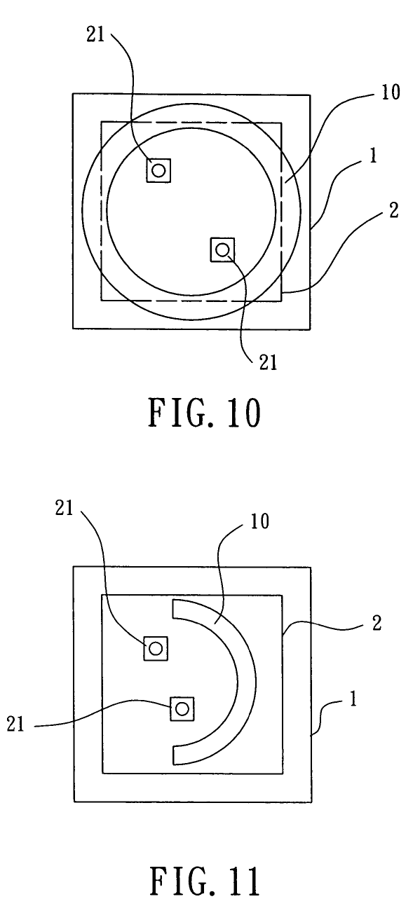

FIGS. 10 and 11 illustrate schematic top views of illustration devices of pattern identification systems in accordance with eighth and ninth embodiments of the present invention.

Referring to FIGS. 10 and 11, reference numerals of the eighth and ninth embodiments of the present invention have applied the identical numerals of the first embodiment, as shown in FIGS. 1 and 2. The pattern identification system in accordance with the eighth and ninth embodiments of the present invention have similar configuration and same function as that of the first embodiment and the detailed descriptions may be omitted.

Turning now to FIG. 10, as is known in the first embodiment, the illumination device 10 of the pattern identification system in accordance with the eighth embodiment has a circular configuration. The circular configuration of the illumination device 10 is arranged along the entire periphery of the stage 1 so as to project uniform light on the sample pattern 2 that may avoid errors of capturing image and identification. Preferably, the circular configuration of the illumination device 10 is consisted of a single illuminator or serial connected illuminators.

In comparison with the eighth embodiment, the illumination device in accordance with the ninth embodiment is modified so that it is suitable for various types and specifications of illuminations.

Turning now to FIG. 11, as is known in the first embodiment, the illumination device 10 of the pattern identification system in accordance with the ninth embodiment has a semicircular configuration. The circular configuration of the illumination device 10 is arranged along the periphery of the stage 1 so as to project uniform light on the sample pattern 2 that may avoid errors of capturing image and identification. Preferably, the semicircular configuration of the illumination device 10 is consisted of a single illuminator or serial connected illuminators.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A pattern identification system, comprising:
an illumination device adapted to project light on a sample pattern;
a video camera unit adapted to magnify an image of the sample pattern with a predetermined magnifying times to obtain an identifiable image of difference sufficient for identification;
a controller connected to the illumination device to turn it on or off, the controller further connected to the video camera unit to capture the identifiable image of the sample pattern; and
a programmable identification member connected to the video camera unit and the controller, the programmable identification member including a recognizing logic adapted to process the identifiable image so as to generate a difference between the identifiable image and the recognizing logic, and the programmable identification member adapted to identify the identifiable image outputted from the video camera unit;
wherein the controller controls the video camera unit to output the identifiable image to the programmable identification member for identification.

2. The pattern identification system as defined in claim 1, further comprising a display device adapted to display an identified result outputted from the programmable identification member.

3. The pattern identification system as defined in claim 1, wherein the illumination device projects a particular wavelength and brightness of light according to various types of the sample pattern.

4. The pattern identification system as defined in claim 1, wherein the video camera unit includes an optically magnifying device.

5. The pattern identification system as defined in claim 1, wherein the video camera unit is adapted to capture a first image of the sample pattern so as to measure a reference coordinate of the sample pattern for selecting a predetermined position.

6. The pattern identification system as defined in claim 1, wherein the video camera unit consisted of a first camera and a second camera, the first camera is adapted to measure a reference coordinate of the sample pattern, and the second camera is adapted to capture the identifiable image for identification.

7. The pattern identification system as defined in claim 1, wherein the video camera unit consisted of a first camera and a second camera, the first camera is adapted to capture an image of a front surface of the sample pattern, and the second camera is adapted to capture an image of a rear surface of the sample pattern.

8. The pattern identification system as defined in claim 7, wherein the second camera captures the image of the rear surface of the sample pattern penetrated through a transparent stage.

9. The pattern identification system as defined in claim 1, wherein the video camera unit is selected from a Charge-Coupled Device or an electronic camera device.

10. The pattern identification system as defined in claim 1, wherein the controller is selected from a group consisted of a control logical circuit, a control IC and a Central Processing Unit.

11. The pattern identification system as defined in claim 1, wherein the programmable identification member is selected from a group consisted of an identification logical circuit and an identification database of a computer software.

12. The pattern identification system as defined in claim 1, wherein the programmable identification member is able to identify features consisted of printing line structure, raised ink, pattern structure, printing color, fiber property, fiber component and fiber density.

13. The pattern identification system as defined in claim 1, wherein the illumination device is consisted of a plurality of illuminations which are used to project a front surface and rear surface of the sample pattern.

14. The pattern identification system as defined in claim 1, wherein the illumination device is consisted of a plurality of illuminations which are disposed above and below a periphery of a stage.

15. The pattern identification system as defined in claim 1, wherein the illumination device includes a mechanism adapted to mechanically adjust its projecting direction so that it has an included angle with respect to a vertical direction.

16. The pattern identification system as defined in claim 1, wherein the illumination device is consisted of a plurality of illuminations which project the sample pattern with multiple projecting angles so that the sample pattern appear multiple angular features.

17. The pattern identification system as defined in claim 1, wherein the illumination device has a circular configuration which is arranged along an entire periphery of a stage so as to project uniform light on the sample pattern that can avoid errors of capturing image and identification; and the circular configuration of the illumination device is consisted of a single illuminator or serial connected illuminators.

18. The pattern identification system as defined in claim 1, wherein the illumination device has a semicircular configuration which is arranged along a predetermined angular length of a periphery of a stage so as to project uniform light on the sample pattern that can avoid errors of capturing image and identification; and the semicircular configuration of the illumination device is consisted of a single illuminator or serial connected illuminators.
